(19) United States
(12) Patent Application Publication
(10) Pub. No.: US 2025/0310187 A1
(43) Pub. Date: Oct. 2, 2025

(54) CONTROL METHOD AND CONTROL SYSTEM

(71) Applicant: Lenovo (Beijing) Limited, Beijing (CN)

(72) Inventors: Yuxing ZHOU, Beijing (CN); Liping WANG, Beijing (CN)

(21) Appl. No.: 19/094,514

(22) Filed: Mar. 28, 2025

(30) Foreign Application Priority Data
Mar. 29, 2024 (CN) 202410381718.3

(51) Int. Cl. H04L 41/0806; H04L 67/12

(52) U.S. Cl. CPC H04L 41/0809; H04L 67/12

(57) ABSTRACT

A control method, applied to a first device, the first device including a first processor and a target sensor, the first processor being configured to configure the target sensor based on first configuration information, the control method including: determining connection state information of a second device, the second device including a second processor, the second processor being configured to configure the target sensor based on second configuration information, the second configuration information and the first configuration information being adapted to different operating systems; and switching the target sensor to a subordinate device of the second device when the second device is connected to the first device to cause the second processor to configure the target sensor based on the second configuration information and receive sensor data from the target sensor.

### CROSS-REFERENCES TO RELATED APPLICATION

This application claims priority to Chinese Patent Application No. 202410381718.3 filed on Mar. 29, 2024, the entire content of which is incorporated herein by reference.

### FIELD OF TECHNOLOGY

The present disclosure relates to the field of computer technology and, more specifically, to a control method and a control system.

### BACKGROUND

In a system that supports mixed use of multiple devices, for example, the mixed use of a tablet and a laptop. The tablet can be plugged into the laptop through a specific connection port such that the two devices can share some hardware or software resources.

However, mixed-use devices generally have different operating systems installed. For example, tablets are installed with the Android operating system, and laptops are installed with the Microsoft Windows operating system. Different operating systems have different sampling rates, data formats or transmission protocols for sensors, which leads to inconsistent data interpretation or loss of some information, limiting the interaction between different operating systems and making it difficult to realize a seamless plug-and-play experience.

### SUMMARY

One aspect of this disclosure provides a control method. The control method is applied to a first device. The first device includes a first processor and a target sensor, and the first processor is configured to configure the target sensor based on first configuration information. The method includes determining connection state information of a second device. The second device includes a second processor, and the second processor is configured to configure the target sensor based on second configuration information. The second configuration information and the first configuration information are adapted to different operating systems. The method further includes switching the target sensor to a subordinate device of the second device when the second device is connected to the first device to cause the second processor to configure the target sensor based on the second configuration information and receive sensor data from the target sensor.

Another aspect of this disclosure provides a control system. The control system includes a first device and a second device. The first device includes a first processor and a target sensor, and the first processor is configured to configure the target sensor based on first configuration information. The second device includes a second processor, and the second processor is configured to configure the target sensor based on second configuration information. The second configuration information and the first configuration information are adapted to different operating systems. The first device and the second device are configured to connect to each other to be used in mix. The first processor is configured to determine connection state information of the second device. The first processor is configured to switch the target sensor to a subordinate device of the second device when the second device is connected to the first device. In response to a switch operation, the second device is configured to configure the target sensor based on the second configuration information and receive sensor data from the target sensor.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a control method according to some embodiments of the present disclosure.

FIG. 2 is a schematic structural diagram of a control system according to some embodiments of the present disclosure.

FIG. 3 is a flowchart of performing control using the control system according to some embodiments of the present disclosure.

FIG. 4 is a flowchart of performing control using the control system according to some embodiments of the present disclosure.

FIG. 5 is a flowchart of performing control using the control system according to some embodiments of the present disclosure.

FIG. 6 is a schematic diagram of a switching timing sequence of the control method according to some embodiments of the present disclosure.

FIG. 7 is a schematic diagram of another switching timing sequence of the control method according to some embodiments of the present disclosure.

FIG. 8 is a schematic structural diagram of a control device according to some embodiments of the present disclosure.

FIG. 9 is a hardware schematic diagram of a computer device according to some embodiments of the present disclosure.

### DETAILED DESCRIPTION

Hereinafter, aspects, features, and embodiments of the present disclosure will be described with reference to the accompanying drawings. Such description is illustrative only but is not intended to limit the scope of the present disclosure. In addition, it will be understood by those skilled in the art that various modifications in form and details may be made therein without departing from the spirit and scope of the present disclosure.

In the specification, terms such as “in one embodiment,” “in another embodiment,” “in an additional embodiment,” or “in other embodiments” may all refer to one or more the same or different embodiments of the present disclosure, which can be combined with each other when there is no conflict.

In the following descriptions, the terms “first,” “second,” and “third” are merely intended to distinguish similar objects but does not necessarily indicate a specific order of an object. It may be understood that the terms “first,” “second,” and “third” are interchangeable in terms of a specific order or sequence if permitted, so that the embodiments of the present disclosure described herein can be implemented in a sequence in addition to the sequence shown or described herein. In the following description, the term “plurality” means at least two.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure.

Embodiments of the present disclosure provide a control method which can be executed by a processor of a computer device. The computer device may be a server, a laptop, a tablet, a desktop computer, a smart TV, a set-top box, a mobile device (e.g., a mobile phone, a portable video player, a personal digital assistant, a dedicated messaging device, a portable gaming device), and other devices with control capabilities.

The control method provided in the present disclosure can be applied to a first device. The first device may include a first processor and a target sensor. The first processor may be configured to configure the target sensor based on first configuration information.

The first device may be one of the mixed-use devices. For example, when a tablet and a laptop are used in mix, the first device may be the tablet. In another example, when a tablet and a desktop are used in mix, the first device may be the tablet. The present disclosure does not limit type of devices that are used in mix.

The first processor may be a computing and/or control unit in the first device. In some embodiments, the first processor may be a central processing unit (CPU) such as an advanced RISC machine (ARM), a multimedia application processor (MAP), or other functional modules with computing and control capabilities.

In some embodiments, the target sensor may be a sensor in the first device that can be shared with the mixed-use device. For example, when the first device is used in combination with other devices, the target sensor may be switched to be a subordinate device of the other device such that the device can directly obtain sensor data from the target sensor.

In some embodiments, there may be one or more target sensors. That is, the first device may share one or more target sensors arranged in the first device with a second device at the same time.

In some embodiments, the target sensor may include any type of sensor such as image sensors, distance sensors, ambient light sensors, gyroscopes and/or accelerometers. The present disclosure does not limit the type of the target sensor.

In some embodiments, the first configuration information may be information used to configure the target sensor. The first configuration information may be adapted to a first operating system installed on the first device. For example, the first configuration information may be adapted to the first operating system's requirements for the target sensor's sampling rate, data format, or transmission protocol.

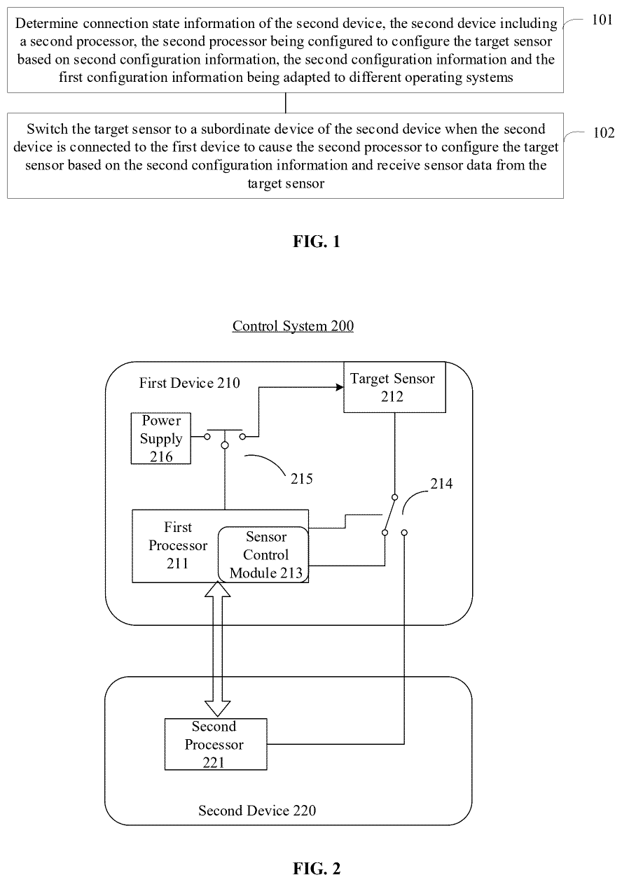

FIG. 1 is a flowchart of a control method according to some embodiments of the present disclosure. The method will be described in detail below.

101, determining connection state information of the second device, the second device including a second processor, the second processor being configured to configure the target sensor based on second configuration information, the second configuration information and the first configuration information being adapted to different operating systems.

In some embodiments, the second device may be a device that can be used in combination with the first device. For example, when the first device is connected to the second device through a designated data interface, the first device may be used in combination with the second device. For example, when the first device and the second device are used in mix, the operating system of the first device may be switched to the background, and the display of the first device may be used to display the operating interface of the second operating system installed in the second device. In another example, when the first device and the second device are used in mix, part of the hardware resources or software resources of the first device may be used by the second device.

In some embodiments, the second processor may be a computing and/or control unit in the second device. For example, the second processor may be a CPU (e.g., an ARM processor), an application processor (MAP), an embedded controller (EC), an embedded controller super input/out (eSIO) or other functional modules with computing and control capabilities.

The second configuration information may be the information used to configure the target sensor. The second configuration information may be adapted to the second operating system installed on the second device. For example, the second configuration information may be adapted to the second operating system's requirements for sampling rate, data format, or transmission protocol of the target sensor.

When the first device and the second device are used in mix, the target sensor may be switched to a subordinate device of the second device such that the second processor can configure the target sensor based on the second configuration information.

The second configuration information and the first configuration information may be adapted to different operating systems. That is, the second operating system and the first operating system may be different operating systems, and they may have different configuration methods for the target sensor. For example, the first operating system may be a Windows operating system, and the second operating system may be an Android operating system.

102, switching the target sensor to a subordinate device of the second device when the second device is connected to the first device to cause the second processor to configure the target sensor based on the second configuration information and receive sensor data from the target sensor.

In some embodiments, in response to the second device being connected to the first device, the first device may switch the target sensor to a subordinate device of the second device. That is, the first device may adjust the device state of the target sensor in the first device to disconnected and stops obtaining sensor data from the target sensor. At the same time, the first device may switch the target device to a subordinate device of the second device such that the second processor can obtain control over the target sensor and obtain sensor data from the target sensor.

In some embodiments, the first device may disconnect the communication connection between the first device and the target sensor by cutting off the communication path between the target sensor and the sensor control module in the first device. At the same time, the first device may switch the target sensor to a subordinate device of the second device by establishing a communication path between the second device and the target sensor.

When the first device switches the target sensor to a subordinate device of the second device, the second device may use the second processor to configure the target sensor based on the second configuration information. Accordingly, the second operating system can obtain sensor data from the target sensor based on the sampling rate, data format, transmission protocol and other requirements specified by the system.

Consistent with the present disclosure, by determining the connection state information of the second device and switching the target sensor to a subordinate device of the second device when the second device is connected to the first device, the second processor can configure the target sensor based on the second configuration information and receive sensor data from the target sensor. Accordingly, by switching the target sensor to a subordinate device of the second device, the second processor of the second device can directly configure the target sensor based on the configuration information adapted to the second operating system, thereby resolving the incompatibility situation when sharing sensor data between different operating systems. In addition, different operating systems can obtain sensor data based on the sensor data sampling rate, data format or transmission protocol of this system, thereby ensuring the security and integrity of sensor data.

In some embodiments, the switching of the target sensor to the subordinate device of the second device, that is, the process at 102, may be implemented as the following processes.

1021, establishing a first communication path between the target sensor and the second processor.

The first communication path between the target sensor and the second processor may include a physical path between the target sensor and the second processor. For example, the first device may establish a first communication path between the target sensor and the second processor by adjusting a connection path of the data pin of the target sensor.

In some embodiments, before the first device establishes the first communication path between the target sensor and the second processor, a second communication path between the first processor of the first device and the target sensor may be disconnected.

1022, determining that the first device meets a preset condition and creating a mapping sensor of the target sensor to cause the first processor to take over the target sensor based on the mapping sensor when the target sensor is switched to a subordinate device of the first device.

The mapping sensor may be the sensor information corresponding to the target sensor without the configuration information. In some embodiments, the mapping sensor may include a simplified version of the second configuration information.

The preset condition may be a preset condition for creating the mapping sensor. In some embodiments, in response to determining that the second device is connected to the first device, a mapping sensor may be created for the target sensor when the first device identifies the target sensor and the target sensor has not been configured.

In some embodiments, the first device meeting the preset condition may include at least one of: after the first device is in a state of switching from a shutdown state to a startup state; after the sensor control module of the first device is restarted; after the sensor control module of the first device switches from a sleep state to a working state; the sensor control module of the first device does not register the target sensor, the sensor control module being configured to centrally manage one or more target sensors.

In some embodiments, the sensor control module of the first device may be the hardware, firmware or software used in the first device to centrally control and manage the sensor.

In some embodiments, when the first device is installed with an Android operating system, the sensor control module may include a smart hub manager (e.g., a sensorhub).

When the first device is in a state of switching from a shutdown state to a startup state, the sensor control module of the first device may start to scan at least one target sensor in the first device. At this time, the sensor control module recognizes the target sensor, but as the second device is connected to the first device, the target sensor is switched to a subordinate device of the second device. Therefore, the sensor control module cannot perform configuration operations on the target sensor, but only create a mapping sensor for the target sensor to realize registration of the target sensor on the sensor control module.

After the sensor control module of the first device is restarted, the sensor control module may rescan and identify at least one target sensor. At this time, the sensor control module recognizes the target sensor, but as the second device is connected to the first device, the target sensor is switched to a subordinate device of the second device. Therefore, the sensor control module cannot perform configuration operations on the target sensor, but only create a mapping sensor for the target sensor to register the target sensor on the sensor control module.

When the sensor control module of the first device is in a sleep state, the power supply of the sensor control module is cut off. Therefore, after the sensor control module switches from the sleep state to the working state, the sensor control module is restarted. Accordingly, after the sensor control module rescans and identifies the target sensor, it is determined that the target sensor is switched to a subordinate device of the second device. Therefore, the sensor control module creates a mapping sensor for the target sensor to realize the registration of the target sensor on the sensor control module.

When the sensor control module of the first device does not register the target sensor (e.g., the sensor control module itself is restarted, or the system itself runs incorrectly and does not register the target sensor), in response to the target sensor being switched to be a subordinate device of the second device, the sensor control module may create a mapping sensor for the target sensor to realize the registration of the target sensor on the sensor control module.

When the first device meets the preset condition, the first device may not configure the target sensor based on the first configuration information, but only create a corresponding mapping sensor for the target sensor. Accordingly, when the target sensor is switched to a subordinate device of the first device, the first device does not need to re-identify the target sensor, but can directly take over the target sensor based on the mapping sensor, thereby avoiding restarting the services related to sensor initialization and saving the target sensor switching time.

In some embodiments, the first device may create the mapping sensor after establishing the first communication path, or the first device may establish the first communication path after creating the mapping sensor, or the first device may create the mapping sensor and establish the first communication path simultaneously. The present disclosure does not limit the execution order of processes 1021 and 1022.

In some embodiments, the process at 1022, creating the mapping sensor of the target sensor may be implemented as the process at 1023.

1023, creating mapping configuration information of the target sensor in the sensor control module of the first device, the mapping configuration information at least including identification information and/or type information of the target sensor, the sensor control module being configured to centrally manage one or more target sensors.

In some embodiments, during the startup of the first device, the service corresponding to the sensor control module may be started to use the sensor control module to perform actions such as scanning, initialization, configuration, and starting the corresponding driver on at least one target sensor.

In some embodiments, the sensor control module may perform only one scanning action on at least one target sensor during one startup. After scanning, the sensor control module may no longer rescan the target sensor on the first device and may only perform sensor configuration on the identified target sensor.

When the target sensor is switched to a subordinate device of the second device and the first device meets the preset condition, the sensor control module can identify the target sensor by performing a scanning. However, since the target sensor is switched to a subordinate device of the second device, the sensor control module cannot perform sensor configuration on the target sensor.

Here, the sensor control module may create the corresponding mapping configuration information for the target sensor to record the identification information and/or type information corresponding to the target sensor in the sensor control module to complete the registration process of the target sensor. Accordingly, when the target sensor is switched to a subordinate device of the first device, the sensor control module can configure the target sensor based on the identification information and/or type information of the target sensor, without restarting the service corresponding to the sensor control module to scan the target sensor, thereby shortening the time from when the target sensor is switched to a subordinate device of the first device to when the first device can obtain the sensing data of the target sensor. Accordingly, the user does not even feel the switching when switching the target sensor, thereby improving the user experience.

In some embodiments, the control method provided in the present disclosure may further include the following process.

103, in response to the second device being disconnected from the first device, switching the target sensor to a subordinate device of the first device.

In some embodiments, the connection between the second device and the first device may be disconnected when the second device is unplugged from the first device; or, when the second device enters a shutdown state; or, when the second device is controlled by a specified software to disconnect the communication connection with the first device.

In some embodiments, in response to the disconnection, the target sensor may be switched back to the subordinate device of the first device to cause the first device to obtain sensor data from the target sensor based on the configuration information.

In some embodiments, by establishing a data connection path between the target sensor and the first processor, the target sensor may be switched to a subordinate device of the first device.

In some embodiments, the process at 102, the first processor taking over the target sensor based on the mapping sensor, may be implemented as the following process.

1024, the sensor control module reconfiguring the mapping sensor based on the mapping configuration information of the mapping sensor and the first configuration information, and receiving sensor data from the target sensor based on the reconfigured mapping sensor.

In some embodiments, in response to the target sensor being switched to be a subordinate device of the first device, the first device may configure the target sensor such that the first processor can obtain sensor data from the target sensor based on the configuration information.

Since the mapping configuration information of the mapping sensor only includes the identification and/or type information of the target sensor/or a simplified version of the target sensor configuration information, therefore, the sensor control module may reconfigure the mapping sensor based on the mapping configuration information of the mapping sensor and the first configuration information.

In some embodiments, in response to the target sensor being switched to a subordinate device of the first device, the sensor control module may determine whether the mapping configuration information corresponding to the target sensor is stored. If the mapping configuration information corresponding to the target sensor is stored, the target sensor may be configured based on the mapping configuration information and the first configuration information. If the mapping configuration information corresponding to the target sensor is not stored, the service corresponding to the sensor control module may be restarted to identify the target sensor, create a mapping senor corresponding to the target sensor, and further configure the mapping sensor using the first configuration information.

In some embodiments, the process at 102, switching the target sensor to a subordinate device of the second device, may be implemented as the following process.

1025, establishing a first communication path between the target sensor and the second processor.

The first communication path between the target sensor and the second processor may include a physical path between the target sensor and the second processor. For example, the first device may establish a first communication path between the target sensor and the second processor by adjusting a connection path of the data pin of the target sensor.

In some embodiments, before the first device establishes the first communication path between the target sensor and the second processor, a second communication path between the first processor of the first device and the target sensor may be disconnected.

1026, determining that the first device does not meet the preset condition and updating the target sensor configuration to cause the first processor to take over the target sensor based on the updated target sensor configuration when the target sensor is switched to a subordinate device of the first device.

The first device not meeting the preset condition may be that the first device does not meet the preset condition for creating a mapping sensor.

In some embodiments, when the first device determines that the second device is connected to the first device and switches the target sensor to a subordinate device of the second device, if the first device has configured the target sensor based on the first configuration information, the first device has stored information including the target sensor identifier, type and configuration data. Accordingly, when the target sensor is switched back to be a subordinate device of the first device, the first device can directly take over the target sensor based on the stored target sensor configuration without creating a mapping sensor for the target sensor.

In some embodiments, the first device not meeting the preset condition may include at least one of: the first device is in a startup state; the sensor control module of the first device is in a working state; the sensor control module of the first device is in a wake-up state; the target sensor is registered with the sensor control module of the first device.

In some embodiments, when the first device is in the startup state, the first device has completed the initialization and configuration of the target sensor during the startup process, therefore, the first device has stored the target sensor configuration and does not need to create a mapping sensor. For example, when the first device is in a startup state, the sensor control module in the first device has completed the initialization and configuration of the target sensor and has stored the target sensor configuration.

Similarly, when the sensor control module of the first device is in the startup state, the sensor control module has completed the initialization and configuration of the target sensor and has stored the target sensor configuration, and there is no need to create a mapping sensor.

In some embodiments, when the sensor control module of the first device is in the wake-up state, the sensor control module has reconfigured the target sensor and stored the target sensor configuration, and there is no need to create a mapping sensor.

When the sensor control module of the first device has registered the target sensor, the sensor control module has stored the mapping sensor of the target sensor or the target sensor configuration, and there is no need to recreate the mapping sensor for the target sensor.

Correspondingly, in response to the target device being switched to a subordinate device of the second device, the target sensor configuration may be updated to an uncalled state such that the first device cannot call the target sensor and obtain sensor data from the target sensor.

At the same time, based on the updated target sensor configuration, when the target sensor is switched back to be a subordinate device of the first device, the first device may directly configure the target sensor using the updated target sensor configuration without re-identifying the target sensor, thereby saving the switching time of the target sensor.

In some embodiments, the process at 103, switching the target sensor to a subordinate device of the first device, may be implemented as the following process.

1031, performing a power-off operation on the target sensor.

In some embodiments, in response to the disconnection between the second device and the first device, the first processor of the first device may disconnect the target sensor from the sensor power supply through a power control instruction such that the target sensor is in a power-off state.

In some embodiments, the first processor may perform a power-off operation by setting a load switch between the target sensor and the sensor power supply to an open state.

1032, establishing a second communication path between the target sensor and the sensor control module.

In some embodiments, the first processor may establish a second communication path between the target sensor and the sensor control module such that the sensor control module can perform a configuration operation on the target sensor and then obtain sensor data from the target sensor based on the configuration information.

In some embodiments, the first processor may establish a second communication path between the target sensor and the sensor control module by adjusting a connection path of a data pin of the target sensor.

In some embodiments, the first processor may establish a second communication path between the target sensor and the sensor control module by adjusting the switch corresponding to the data pin of the target sensor to connect to the sensor control module.

1033, performing a power-on operation on the target sensor.

In some embodiments, in response to establishing the second communication path, the first processor may perform a power-on operation on the target sensor through a power control instruction such that the target sensor can be discovered by the sensor control module.

In some embodiments, the first processor may perform a power-on operation by setting a load switch between the target sensor and the sensor power supply to a connected state.

In some embodiments, the processes at 1021 and 1025, establishing a first communication path between the target sensor and the second processor, may be implemented as the following processes.

1027, the first processor controlling and disconnecting power to the target sensor.

In some embodiments, in response to the connection between the second device and the first device, the first processor may disconnect the target sensor from the sensor power supply through a power control instruction such that the target sensor is in a power-off state.

In some embodiments, the first processor may perform a power-off operation by setting a load switch between the target sensor and the sensor power supply to an open state.

1028, in response to detecting that the power supply to the target sensor is disconnected, the first processor controlling a switch to switch from a second state to a first state.

In some embodiments, the switch may be used to control the connection state of the data path of the target sensor.

When the switch is in the first state, the data path of the target sensor may be connected to the second processor of the second device to cause the target sensor to act as a subordinate device of the second device. When the switch is in the second state, the data path of the target sensor may be connected to the sensor control module of the first device to cause the target sensor to act as a subordinate device of the first device.

In some embodiments, the switch may be a single-pole double-throw switch, which can used to switch the data path of the target sensor to the sensor control module or the second processor.

1029, sending a first control instruction to the second processor to cause the second processor to configure the target sensor with second configuration information to establish a first communication path between the target sensor and the second processor.

In some embodiments, after the state of the switch is switched to the first state, the first processor may send a first control instruction to the second processor to notify the second processor that the target sensor has been switched to a subordinate device of the second device. Accordingly, the second processor can configure the target sensor based on the second configuration information to establish a first communication path between the target sensor and the second processor.

In some embodiments, after the first processor switches the state of the switch to the first state, the first processor may perform a power-on operation on the target sensor.

Consistent with the present disclosure, when the second device is connected to the first device, the first device can switch the target sensor installed in the first device to a subordinate device of the second device, such that the second processor of the second device can configure the target sensor based on the second configuration information and receive sensor data from the target sensor. The first processor of the first device can configure the target sensor based on the first configuration information, and the first configuration information and the second configuration information can be adapted to different operating systems. Accordingly, when devices with different operating systems are used in mix, the target sensor can be directly switched to a subordinate device of the second device. Accordingly, the second device can configure the target device based on the configuration information adapted to the device, thus avoiding the incompatibility situation when mixed devices share sensor data. In addition, when the first device switches the target sensor to a subordinate device of the second device, a mapping sensor can be created for the target sensor in the sensor control module of the first device if the first device meets the preset conditions. Accordingly, when the target sensor is switched to a subordinate device of the first device, the sensor control module can configure the target sensor based on the mapping sensor without restarting the service corresponding to the sensor control module to initialize and configure the target sensor. This shortens the switching time of the target sensor, and the user may not even feel the switching time, and the sensor function will not be lost, thereby improving the user experience.

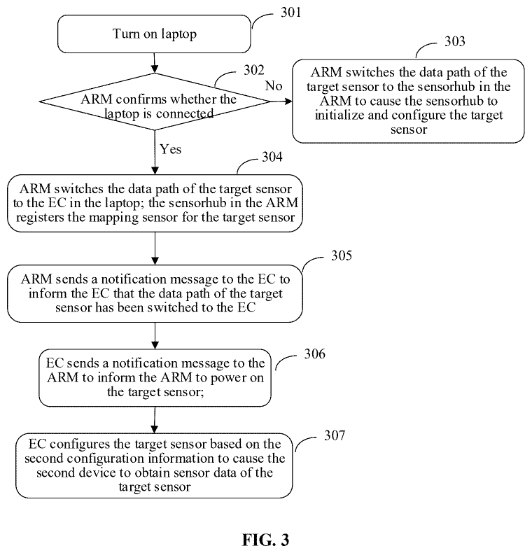

Based on the control method provided in the present disclosure, an embodiment of the present disclosure also provides a control system. FIG. 2 is a schematic structural diagram of a control system 200 according to some embodiments of the present disclosure. As shown in FIG. 2, the control system 200 includes a first device 210 and a second device 220. The first device 210 includes a first processor 211 and a target sensor 212. The first processor 211 may be configured to configure the target sensor 212 based on the first configuration information. The second device 220 includes a second processor 221. The second processor 221 may be configured to configure the target sensor 212 based on the second configuration information. The second configuration information and the first configuration information may be adapted to different operating systems. The first device 210 and the second device 220 may be connected to each other to be used in combination.

In some embodiments, the first processor 211 may be configured to determine the connection state information of the second device 220. When the second device 220 is connected to the first device 210, the first processor 211 may switch the target sensor 212 to a subordinate device of the second device 220. Further, in response to the switching operation, the second processor 221 may configure the target sensor 212 based on the second configuration information and receive sensor data from the target sensor 212.

In some embodiments, a data path may be established between the first processor 211 and the second processor 221 to exchange data signals with each other. In some embodiments, the first processor 211 and the second processor 221 may be connected via a detection (DET) pin.

In some embodiments, the second processor 221 may be a device having a sensor management function, such as a CPU, EC, or eSIO in the second device 220.

In some embodiments, the first device 210 may also include a sensor control module 213. The sensor control module 213 may be a service in the first processor 211 for centrally controlling and managing the sensor. For example, when the first operating system installed in the first device is an Android operating system, the sensor control module may be a sensorhub.

As described above, when the target sensor 212 is switched to the second device 220 and the first device 210 meets the preset condition, the sensor control module 213 may create a mapping sensor of the target sensor 212. When the target sensor 212 is switched to a subordinate device of the first device 210, a second communication path may be established between the target sensor 212 and the sensor control module 213, and the sensor control module 213 may reconfigure the mapping sensor based on the mapping configuration information of the mapping sensor and the first configuration information, and receive sensor data from the target sensor 212 based on the reconfigured mapping sensor.

In some embodiments, the first device may also include a first switch 214. The first switch 214 may be a single-pole double-throw switch, which can be used to control the data path of the target sensor 212 based on the control instruction of the first processor 211. The first switch 214 includes a first state and a second state. When the first switch 214 is in the first state, the active end of the first switch 214 may be connected to the second processor 221 to establish a path between the target sensor 212 and the second processor 221. When the first switch 214 is in the second state, the active end of the first switch 214 may be connected to the sensor control module 213 to establish a path between the target sensor 212 and the sensor control module 213.

In some embodiments, the first device may also include a second switch 215. The second switch 215 may be used to control the connection state between the target sensor 212 and a power supply 216 based on the control instruction of the first processor 211, thereby realizing the power-on and power-off switching of the target sensor 212.

It should be noted that the descriptions of the above control system embodiments are similar to the description of the above method embodiments. The control system embodiments have similar advantageous effects with those of the method embodiments and thus the description thereof will be omitted here. In some embodiments, the functions or module included in the system provided by the embodiments of the present disclosure can be used to execute the method described in the foregoing method embodiments. For those technical details not mentioned in the above control system embodiments, reference can be made to the description of the above method embodiments and the description thereof will be omitted here for simplicity.

The following description takes the first device as a tablet, the sensor control module in the first device as a sensorhub, and the second device as a laptop as an example. In combination with FIG. 3 to FIG. 5, an application example of performing control using the control system provided by the present disclosure is described in detail. Here, the processor installed in the tablet is an ARM processor, and the second processor used to control the sensor in the laptop is an EC.

Refer to FIG. 3, which illustrate an example of switching the target sensor to a subordinate device of the laptop when both the tablet and the laptop are turned on from the off state. As shown in FIG. 3, this example includes processes 301 to 307.

301, turn on the tablet; then perform the process at 302.

302, ARM confirms whether the laptop is connected; if not, perform the process at 303; if yes, perform the process at 304.

303, ARM switches the data path of the target sensor to the sensorhub in the ARM to cause the sensorhub to initialize and configure the target sensor.

304, ARM switches the data path of the target sensor to the EC in the laptop; the sensorhub in the ARM registers the mapping sensor for the target sensor; then, perform the process at 305.

305, ARM sends a notification message to the EC to inform the EC that the data path of the target sensor has been switched to the EC; then, perform the process at 306.

306, EC sends a notification message to the ARM to inform the ARM to power on the target sensor; then, perform the process at 307.

307, EC configures the target sensor based on the second configuration information to cause the second device to obtain sensor data of the target sensor.

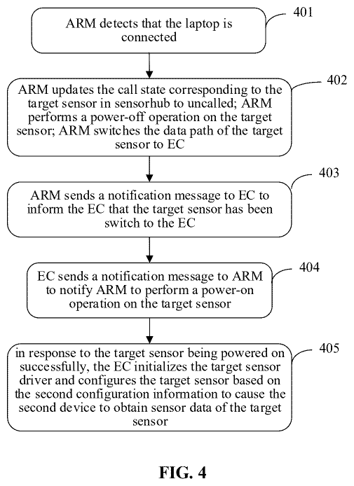

Refer to FIG. 4, which illustrate an example of, when the tablet is powered on, the tablet detects that the laptop is connected to the tablet and switches the target sensor to a subordinate device of the laptop. As shown in FIG. 4, this example includes processes 401 to 405.

401, ARM detects that the laptop is connected; then, perform the process at 402.

402, ARM updates the call state corresponding to the target sensor in sensorhub to uncalled; ARM performs a power-off operation on the target sensor; ARM switches the data path of the target sensor to EC; then, perform the process at 403.

403, ARM sends a notification message to EC to inform the EC that the target sensor has been switch to the EC; then, perform the process at 404.

404, EC sends a notification message to ARM to notify ARM to perform a power-on operation on the target sensor; then, perform the process at 405.

405, in response to the target sensor being powered on successfully, EC initializes the target sensor driver and configures the target sensor based on the second configuration information to cause the second device to obtain sensor data of the target sensor.

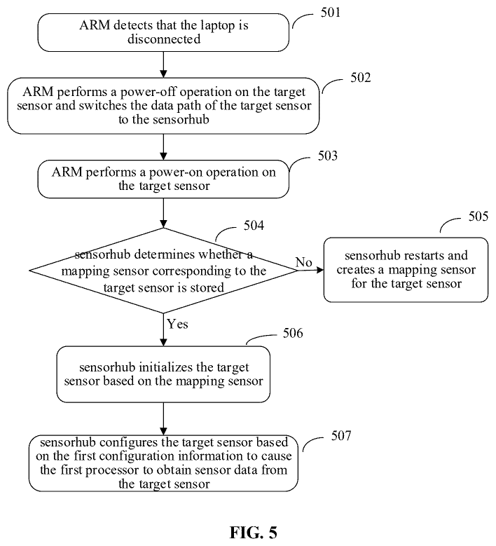

Refer to FIG. 5, which illustrate an example of switching the target sensor to a subordinate device of the tablet after the tablet detects that the laptop is disconnected. As shown in FIG. 5, this example includes processes 501 to 507.

501, ARM detects that the laptop is disconnected; then, perform the process at 502.

502, ARM performs a power-off operation on the target sensor and switches the data path of the target sensor to the sensorhub; then, perform the process at 503.

503, ARM performs a power-on operation on the target sensor; then, perform the process at 504.

504, sensorhub determines whether a mapping sensor corresponding to the target sensor is stored; if not, perform the process at 505; if yes, perform the process at 506.

505, sensorhub restarts and creates a mapping sensor for the target sensor; then, perform the process at 507.

506, sensorhub initializes the target sensor based on the mapping sensor; then, perform the process at 507.

507, sensorhub configures the target sensor based on the first configuration information to cause the first processor to obtain sensor data from the target sensor.

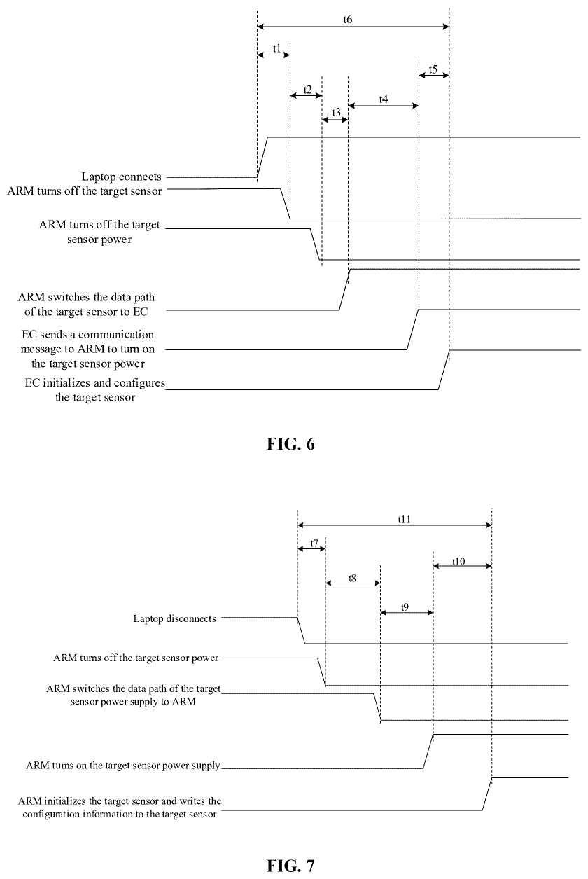

The following description takes the first device as a tablet and the second device as a laptop as an example. In combination with FIG. 6, the signal switching timing for switching the target sensor to the subordinate device of the laptop when the laptop is connected is described below. Here, the processor in the tablet is an ARM processor, and the second processor in the laptop is an EC. As shown in FIG. 6, the switching timing is as follows.

The laptop connects. Here, when the DET pin is used to connect the tablet and the laptop detects a high potential signal, the ARM determines that the laptop is connected to the tablet.

ARM turns off the target sensor. Here, the ARM turns off the target sensor by pulling down the signal line of the call state corresponding to the target sensor. The time from when the laptop is connected to when the ARM pulls down the signal line corresponding to the call state of the target sensor is noted as t1.

ARM turns off the target sensor power. Here, the ARM turns off the target sensor power supply by cutting off the circuit between the target sensor and the sensor power supply. The time from when the ARM pulls down the signal line corresponding to the target sensor call state to when the ARM turns off the power of the target sensor is noted as t2.

ARM switches the data path of the target sensor to EC. Here, the ARM switches the single-pole double-throw switch corresponding to the data path of the target sensor to the EC. The time from when the ARM turns off the power supply of the target sensor to when the ARM switches the data path of the target sensor to the EC is noted as t3.

EC sends a communication message to ARM to turn on the target sensor power. The time from when the ARM switches the data path of the target sensor to the EC to when the EC sends a communication message to the ARM to turn on the power of the target sensor is noted as t4.

EC initializes and configures the target sensor. The time from when the EC sends a communication message to the ARM to turn on the power of the target sensor to when the EC initializes and configures the target sensor is noted as t5.

The total time from the laptop connection to the EC initializing and configuring the target sensor is noted as t6 .

After testing, the minimum and maximum values of the duration used in the above switching timing are shown in Table 1 below.

TABLE 1

| Time (ms) | Minimum Value | Maximum Value |
|---|---|---|
| t1 | 0 | — |
| t2 | 0 | 20 |
| t3 | 50 | 0 |
| t4 | 100 | 200 |
| t5 | — | 200 |
| t6 | 150 | 600 |

As can be seen from Table 1, when the tablet is connected to the laptop, the control method provided by the present application can switch the target sensor to the laptop for use in a very short time, thereby avoiding the long switching time and causing the user to experience the loss of sensor function.

The following description takes the first device as a tablet and the second device as a laptop as an example. In combination with FIG. 7, the signal switching timing for switching the target sensor to the tablet's subordinate device when the laptop is disconnected from the tablet is described below. Here, the processor in the tablet is an ARM processor, and the second processor in the laptop is an EC. As shown in FIG. 7, the switching timing is as follows.

The laptop disconnects. Here, in response to the DET pin detecting a low potential, the ARM determines that the laptop is disconnected.

ARM turns off the target sensor power. Here, the ARM turns off the target sensor power supply by cutting off the circuit between the target sensor and the sensor power supply. The time from when the laptop is disconnected to when the ARM turns off the power to the target sensor is noted as t7.

ARM switches the data path of the target sensor power supply to ARM. Here, the ARM switches the single-pole double-throw switch corresponding to the data path of the target sensor to the ARM. The time from when the ARM turns off the target sensor power supply to when the ARM switches the data path of the target sensor power supply to ARM is noted as t8.

ARM turns on the target sensor power supply. Here, the ARM turns on the target sensor power supply by connecting the circuit between the target sensor and the sensor power supply. The time from when the ARM switches the data path of the target sensor power supply to the ARM to when the ARM turns on the target sensor power supply is noted as t9.

ARM initializes the target sensor and writes the configuration information to the target sensor. The time from when the ARM turns on the power of the target sensor to when the ARM initializes the target sensor and writes the configuration information to the target sensor is noted as t10.

The total time from the laptop disconnection to the ARM initializing the target sensor and writing the configuration information to the target sensor is noted as t11.

After testing, the minimum and maximum values of the duration used in the above switching timing are shown in Table 2 below.

TABLE 2

| Time (ms) | Minimum Value | Maximum Value |
|---|---|---|
| t7 | 0 | — |
| t8 | 100 | 200 |
| t9 | 100 | 200 |
| t10 | — | 200 |
| t11 | 250 | 600 |

As can be seen from Table 2, when the tablet is disconnected from the laptop, the control method provided by the present application can switch the target sensor to the tablet for use in a very short time, thereby avoiding the long switching time and causing the user to experience the loss of sensor function.

The present disclosure also provides a control device. Units included in the device, and modules included in the units, may all or partially be implemented by a processor in the control device. They may all or partially be implemented by a specific logic circuit. The processor may be a central processing unit (CPU), a microprocessor (MPU), a digital signal processor (DSP), or a field programmable gate array (FPGA), etc.

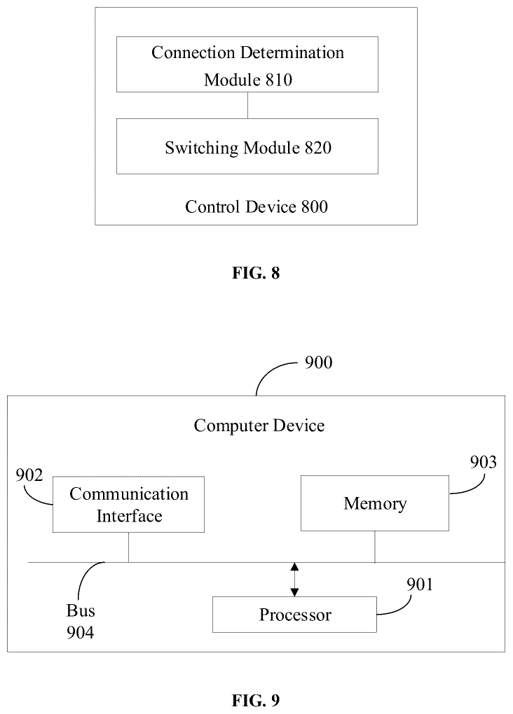

FIG. 8 is a schematic structural diagram of a control device 800 arranged on the first device according to some embodiments of the present disclosure. As shown in FIG. 8, the control device 800 includes a connection determination module 810 and a switching module 820.

In some embodiments, the first device may include a first processor and a target sensor. The first processor may be configured to configure the target sensor based on the first configuration information.

In some embodiments, the connection determination module 810 may be configured to determine the connection state information of the second device. The second device may include a second processor, the second processor being configured to configure the target sensor based on second configuration information. The second configuration information and the first configuration information may be adapted to different operating systems.

In some embodiments, the switching module 820 may be configured to switch the target sensor to a subordinate device of the second device when the second device is connected to the first device to cause the second processor to configure the target sensor based on the second configuration information and receive sensor data from the target sensor.

In some embodiments, the switching module 820 may include a path establishing module 821 and a registration module 822. The path establishing module 821 may be configured to establish a first communication path between the target sensor and the second processor. The registration module 822 may be configured to determine that the first device meets a preset condition and creating a mapping sensor of the target sensor to cause the first processor to take over the target sensor based on the mapping sensor when the target sensor is switched to a subordinate device of the first device.

In some embodiments, the registration module 822 may be configured to create the mapping configuration information of the target sensor in the sensor control module of the first device, the mapping configuration information at least including identification information and/or type information of the target sensor, the sensor control module being configured to centrally manage one or more target sensors.

In some embodiments, the switching module 820 may be further configured to, in response to the second device being disconnected from the first device, switch the target sensor to a subordinate device of the first device.

In some embodiments, the control device 800 may further incudes a sensor control module 830. The sensor control module 830 may be configured to reconfigure the mapping sensor based on the mapping configuration information of the mapping sensor and the first configuration information, and receive sensor data from the target sensor based on the reconfigured mapping sensor.

In some embodiments, the first device meeting the preset condition may include at least one of: after the first device is in a state of switching from a shutdown state to a startup state; after the sensor control module of the first device is restarted; after the sensor control module of the first device switches from a sleep state to a working state; the sensor control module of the first device does not register the target sensor, the sensor control module being configured to centrally manage one or more target sensors.

In some embodiments, the path establishing module 821 may be configured to establish a first communication path between the target sensor and the second processor. The registration module 822 may be configured to determine that the first device does not meet the preset condition and update the target sensor configuration to cause the first processor to take over the target sensor based on the updated target sensor configuration when the target sensor is switched to a subordinate device of the first device.

In some embodiments, the first device not meeting the preset condition may include at least one of: the first device is in a startup state; the sensor control module of the first device is in a working state; the sensor control module of the first device is in a wake-up state; the target sensor is registered with the sensor control module of the first device.

In some embodiments, the switching module 820 may be configured to perform a power-off operation on the target sensor; establish a second communication path between the target sensor and the sensor control module; and, perform a power-on operation on the target sensor.

In some embodiments, the path establishing module 821 may be configured to control and disconnect, by the first processor, power to the target sensor; in response to detecting that the power supply to the target sensor is disconnected, control, by the first processor, a switch to switch from a second state to a first state; send a first control instruction to the second processor to cause the second processor to configure the target sensor with second configuration information to establish a first communication path between the target sensor and the second processor.

It should be noted that the descriptions of the above control device embodiments are similar to the description of the above method embodiments. The control device embodiments have similar advantageous effects with those of the method embodiments and thus the description thereof will be omitted here. In some embodiments, the functions or module included in the system provided by the embodiments of the present disclosure can be used to execute the method described in the foregoing method embodiments. For those technical details not mentioned in the above control device embodiments, reference can be made to the description of the above method embodiments and the description thereof will be omitted here for simplicity.

In some embodiments, the control method provided by the present disclosure may be implemented in the form of a software function module and may be sold or used as an independent product. Therefore, it may be stored in a computer-readable storage medium. Based on this understanding, the technical solutions of the embodiments of the present disclosure that are essentially or contribute to related technologies may be embodied in the form of a software product. The software product may be stored in a storage medium and may include instructions to enable a computer device (which may be a personal computer, a server, a network device, etc.) to execute all or part of the methods described in various embodiments of the present disclosure. The aforementioned storage media may include: a flash disk, a mobile hard disk, a read only memory (ROM), a magnetic disk, an optical disk, or other media that can store program codes. The embodiments of the present disclosure are not limited to any specific hardware, software, or firmware, or any combination of hardware, software, and firmware.

The present disclosure also provides a computer device. The computer device may include a processor and a memory. The memory may be configured to store computer programs that are able to be executed in the processor. The processor may execute the computer programs to implement all or a part of the multimedia data recording methods provided by the present disclosure.

Correspondingly, one embodiment of the present disclosure provides a computer-readable storage medium configured to store computer programs. When the computer programs are executed by a processor, all or a part of the multimedia data recording methods provided by the present disclosure may be implemented. The computer-readable storage medium may be volatile or non-volatile.

Correspondingly, one embodiment of the present disclosure provides a computer program including computer-readable codes. When the computer program is executed in a computer device, a processor in the computer device may execute any of the methods described in the above embodiments.

An embodiment of the present disclosure also provides a computer program product. The computer program product may include a non-volatile computer-readable storage medium storing a computer program. When the computer program is read and executed by a computer, all or a part of the above methods may be implemented. The computer program product may be implemented specifically through hardware, software or a combination thereof. In some embodiments, the computer program product may be embodied as a computer storage medium. In other embodiments, the computer program product may be embodied as a software product, such as a software development kit (SDK) and so on.

Each embodiment in this specification is described in a progressive mode, and each embodiment focuses on the difference from other embodiments. Same and similar parts of each embodiment may be referred to each other. As for the device, computer-readable storage medium and computer program disclosed in the embodiments, since it corresponds to the method disclosed in the foregoing embodiments, the description is relatively simple, and for relevant details, the reference may be made to the description of the method embodiments.

FIG. 9 is a hardware schematic diagram of a computer device 900 according to some embodiments of the present disclosure. As shown in FIG. 9, the hardware of the computer device 900 includes a processor 901, a communication interface 902 and a memory 903.

The processor 901 may be configured to generally control the overall operation of computer device 900.

The communication interface 902 may be configured to enable the computer device to communicate with other terminals or servers through a network.

The memory 903 may be configured to store instructions and applications executable by the processor 791, and may also cache data to be processed or processed by the processor 901 and each module in the computer device 900 (e.g., image data, audio data, voice communication data, or video communication data). The memory may be implemented through flash memory (FLASH) or random-access memory (RAM). Data transmission may be carried out between the processor 901, the communication interface 902 and the memory 903 through a bus 904.

It is to be noted that the term “one embodiment” or “an embodiment” as used throughout the description means that the specific features, structures or characteristics associated with the embodiment are included in at least one embodiment of the present disclosure. Hence, the expression “in one embodiment” or “in an embodiment” as used throughout the description does not necessarily refer to the same embodiment. Further, these specific features, structures or characteristics can be arbitrarily combined in one or more embodiments as appropriate. It should be appreciated that, in various embodiments of the present disclosure, the numbering of the above processes does not mean the order in which they are executed. The order in which the processes are executed should be determined by their functions and internal logics, rather than being limited to any embodiment of the present disclosure. The numbering of the above embodiments is used for the purpose of illustration only, but does not imply any preference among those embodiments.

It is to be noted here that the terms “including” or “comprising” or any variants thereof as used herein are not exclusive, such that a process, method, article or apparatus including/comprising a number of elements may also include/comprise other elements that are not explicitly listed or inherent to the process, method, article or apparatus. If not limited otherwise, an element included in process, method, article or apparatus does not exclude a situation where the process, method, article or apparatus including the element further includes one or more identical elements.

It can be appreciated from the embodiments of the present disclosure that the disclosed method and device can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

It can be appreciated by those skilled in the art that some or all of the steps in the method embodiments as described above can be implemented by hardware following instructions of a program. Such program can be stored in a computer readable storage medium and, when executed, performs the steps of the above method embodiments. The storage medium may be any of various mediums capable of storing program codes, such as a mobile storage device, a read-only memory (ROM), a random-access Memory (RAM), a magnetic disk or an optical disc.

Alternatively, when the above integrated units of the present disclosure are implemented in software functional modules and sold or used as a standalone product, they can be stored in a computer readable storage medium. In view of this, the technical solutions according to the embodiments of the present disclosure, or in other words a part thereof which makes contribution over the prior art, can be substantially embodied in a form of software product. The computer software product can be stored in a storage medium, such as ROM/RAM, magnetic disk, optical disc and the like, containing instructions which cause a computer device (which can be a personal computer, a server, a network device or the like) to perform one or more methods according to the embodiments of the present disclosure or particular parts thereof. The storage medium may be any of various mediums capable of storing program codes, such as a mobile storage device, a ROM, a RAM, a magnetic disk or an optical disc.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims.

What is claimed is:

1. A control method, applied to a first device, the first device including a first processor and a target sensor, the first processor being configured to configure the target sensor based on first configuration information, comprising:
determining connection state information of a second device, the second device including a second processor, the second processor being configured to configure the target sensor based on second configuration information, the second configuration information and the first configuration information being adapted to different operating systems; and
switching the target sensor to a subordinate device of the second device when the second device is connected to the first device to cause the second processor to configure the target sensor based on the second configuration information and receive sensor data from the target sensor.

2. The method of claim 1, wherein switching the target sensor to the subordinate device of the second device includes:
establishing a first communication path between the target sensor and the second processor;
determining that the first device meets a preset condition and creating a mapping sensor of the target sensor to cause the first processor to take over the target sensor based on the mapping sensor when the target sensor is switched to be a subordinate device of the first device.

3. The method of claim 2, wherein creating the mapping sensor of the target sensor includes:
creating mapping configuration information of the target sensor in a sensor control module of the first device, the mapping configuration information at least including identification information and/or type information of the target sensor, the sensor control module being configured to centrally manage one or more target sensors.

4. The method of claim 3 further comprising:
in response to the second device being disconnected from the first device, switching the target sensor to the subordinate device of the first device; wherein, the first processor taking over the target sensor based on the mapping sensor includes:
reconfiguring, by the sensor control module, the mapping sensor based on the mapping configuration information of the mapping sensor and the first configuration information, and
receiving the sensor data from the target sensor based on the reconfigured mapping sensor.

5. The method of claim 2, wherein the first device meeting the preset condition includes one or more of:
after the first device switches from a shutdown state to a startup state;
after the sensor control module of the first device is restarted;
after the sensor control module of the first device switches from a sleep state to a working state; and
the sensor control module of the first device does not register the target sensor, the sensor control module being configured to centrally manage one or more target sensors.

6. The method of claim 2, wherein switching the target sensor to the subordinate device of the second device includes:
establishing the first communication path between the target sensor and the second processor;
determining that the first device does not meet the preset condition and updating a target sensor configuration to cause the first processor to take over the target sensor based on the updated target sensor configuration when the target sensor is switched to be the subordinate device of the first device.

7. The method of claim 6, wherein the first device not meeting the preset condition including one or more of:
the first device is in the startup state;
the sensor control module of the first device is in the working state;
the sensor control module of the first device is in a wake-up state; and
the target sensor is registered with the sensor control module of the first device.

8. The method of claim 3, wherein switching the target sensor to be the subordinate device of the first device includes:
performing a power-off operation on the target sensor; and
establishing a second communication path between the target sensor and the sensor control module; and
performing a power-on operation on the target sensor.

9. The method of claim 2, wherein establishing the first communication path between the target sensor and the second processor includes:
controlling, by the first processor, to disconnect a power supply of the target sensor;
in response to detecting that the power supply of the target sensor is disconnected, controlling, by the first processor, a switch to switch from a second state to a first state; and
sending a first control instruction to the second processor to cause the second processor to configure the target sensor based on the second configuration information to establish the first communication path between the target sensor and the second processor.

10. A control system comprising:
a first device, the first device including a first processor and a target sensor, the first processor being configured to configure the target sensor based on first configuration information; and
a second device, the second device including a second processor, the second processor being configured to configure the target sensor based on second configuration information, the second configuration information and the first configuration information being adapted to different operating systems, wherein:
the first device and the second device are configured to connect to each other to be used in mix;
the first processor is configured to determine connection state information of the second device;
the first processor is configured to switch the target sensor to a subordinate device of the second device when the second device is connected to the first device; and
in response to a switch operation, the second device is configured to configure the target sensor based on the second configuration information and receive sensor data from the target sensor.

11. A computer readable storage medium storing one or more computer program instructions, when executed by one or more processors, the computer program instructions implementing a control method, applied to a first device, the first device including a first processor and a target sensor, the first processor being configured to configure the target sensor based on first configuration information, the control method comprising:
determining connection state information of a second device, the second device including a second processor, the second processor being configured to configure the target sensor based on second configuration information, the second configuration information and the first configuration information being adapted to different operating systems; and
switching the target sensor to a subordinate device of the second device when the second device is connected to the first device to cause the second processor to configure the target sensor based on the second configuration information and receive sensor data from the target sensor.

12. The computer readable storage medium of claim 11, wherein switching the target sensor to the subordinate device of the second device includes:
establishing a first communication path between the target sensor and the second processor;
determining that the first device meets a preset condition and creating a mapping sensor of the target sensor to cause the first processor to take over the target sensor based on the mapping sensor when the target sensor is switched to be a subordinate device of the first device.

13. The computer readable storage medium of claim 12, wherein creating the mapping sensor of the target sensor includes:
creating mapping configuration information of the target sensor in a sensor control module of the first device, the mapping configuration information at least including identification information and/or type information of the target sensor, the sensor control module being configured to centrally manage one or more target sensors.

14. The computer readable storage medium of claim 13, the control method further comprising:
in response to the second device being disconnected from the first device, switching the target sensor to the subordinate device of the first device; wherein, the first processor taking over the target sensor based on the mapping sensor includes:
reconfiguring, by the sensor control module, the mapping sensor based on the mapping configuration information of the mapping sensor and the first configuration information, and
receiving the sensor data from the target sensor based on the reconfigured mapping sensor.

15. The computer readable storage medium of claim 12, wherein the first device meeting the preset condition includes one or more of:
after the first device switches from a shutdown state to a startup state;
after the sensor control module of the first device is restarted;
after the sensor control module of the first device switches from a sleep state to a working state; and
the sensor control module of the first device does not register the target sensor, the sensor control module being configured to centrally manage one or more target sensors.

16. The computer readable storage medium of claim 12, wherein switching the target sensor to the subordinate device of the second device includes:
establishing the first communication path between the target sensor and the second processor;
determining that the first device does not meet the preset condition and updating a target sensor configuration to cause the first processor to take over the target sensor based on the updated target sensor configuration when the target sensor is switched to be the subordinate device of the first device.

17. The computer readable storage medium of claim 16, wherein the first device not meeting the preset condition including one or more of:
the first device is in the startup state;
the sensor control module of the first device is in the working state;
the sensor control module of the first device is in a wake-up state; and
the target sensor is registered with the sensor control module of the first device.

18. The computer readable storage medium of claim 13, wherein switching the target sensor to be the subordinate device of the first device includes:
performing a power-off operation on the target sensor; and
establishing a second communication path between the target sensor and the sensor control module; and
performing a power-on operation on the target sensor.

19. The computer readable storage medium of claim 12, wherein establishing the first communication path between the target sensor and the second processor includes:
controlling, by the first processor, to disconnect a power supply of the target sensor;
in response to detecting that the power supply of the target sensor is disconnected, controlling, by the first processor, a switch to switch from a second state to a first state; and
sending a first control instruction to the second processor to cause the second processor to configure the target sensor based on the second configuration information to establish the first communication path between the target sensor and the second processor.
